(19) United States
(12) Patent Application Publication
(10) Pub. No.: US 2019/0066171 A1
(43) Pub. Date: Feb. 28, 2019

(54) TRADESMAN BUSINESS PURCHASE SYSTEM

(71) Applicant: Charlie Newmark, Marina Del Rey, CA (US)

(72) Inventor: Charlie Newmark, Marina Del Rey, CA (US)

(21) Appl. No.: 15/687,105

(22) Filed: Aug. 25, 2017

(51) Int. Cl. G06Q 30/06; G06K 9/00

(52) U.S. Cl. CPC G06Q 30/06; G06Q 40/00; G06K 9/00006

(57) ABSTRACT

A tradesman business purchase system is provided to qualifying tradesmen by a bank or credit issuing authority upon payment of an initiation fee and payment of periodic maintenance fees. The tradesman requests a line of credit funding a business account based on submission of proof that the tradesman belongs to a recognized group of professionals entitled to tradesman status, and, optionally, a personal savings account at the bank and other financial resources. During initiation of the tradesman business purchase system, biometric data of the tradesman are acquired, including fingerprint, face recognition, palm scan and iris scan and the biometric data along with the line of credit is stored in a remote web based database. The tradesman at the merchant location is uniquely recognized by presentation of a card containing indicia that verifies the tradesman's status and, optionally, first biometric data of fingerprint, optionally followed by second biometric data of face recognition, palm scan or iris scan, all verified by a remote web based database. Business purchases made by the tradesman are posted in the line of credit funded business account generating monthly bills. The purchases are subject to pre-negotiated discounts at pre-selected wholesalers, jobbers and business establishments chosen by the tradesman. The trade purchases by the tradesman are tracked, analyzed and reported to sponsoring manufacturers, wholesalers or jobbers for marketing purposes and generation of special discounts or future purchases.

### BACKGROUND OF THE INVENTION

### 1. Field of the Invention

The present invention relates to a tradesman business purchase system that identifies the participating tradesman upon submission of proof that the trademan belongs to a recognized class of professionals entitled to receive tradesman's status and, optionally, using biometric identifiers without requiring a credit card or any other form of identification; more particularly, to a system that is linked to tradesman's account at a bank or credit issuing authority and provides unique services and discounts for a tradesman in connection with the purchase of professional goods or services from a wholesaler or jobber that recognizes the tradesman as a certified and or qualified buyer and member of a particular field, and provides discounts recognizing the tradesman as a professional.

### 2. Description of the Prior Art

Many patents address issues related to identification of a person using biometric markers. Biometric identification systems can be grouped on the basis of the main physical characteristic that characterize biometric identification. These biometric markers include fingerprint or thumb print identification, face recognition, hand geometry biometrics, iris scan, retina scan and voice recognition. Some of these biometric measurements are easily implemented at a tradesman purchasing location, while others are difficult to implement due to complications including processing machinery, software requirements and the like. The tradesman purchasing location needs to link with the bank or credit issuing authority to process the purchases made by the tradesman. These prior art disclosures focus on different biometric measurement systems but do not provide a tradesman biometric purchasing system. None of these patents discloses a tradesman purchasing system that is specifically designed for a tradesman that purchases trade specific supplies, and none of them recognizes the tradesman as a member of a unique profession entitled to receive a special discount or incentives.

U.S. Pat. No. 5,764,789 to Pare, Jr. et al. discloses a tokenless biometric ATM access system. The system provides a system and method for having a customer register with a computer system. a PIN, one or more registration biometric samples, and one or more of the customer's financial accounts. During an initiation step, the customer initiates an account access at an ATM or a PC or other financial access device, by entering the customer's personal authentication information comprising a PIN and at least one bid biometric sample. No portable man-made memory devices such as smartcards or swipe cards are used in this step. In a transmission step, an account access request message comprising the personal authentication information of the customer and other data are forwarded from the ATM to the computer system. After the computer system receives the personal authentication information in the account access request message, the personal authentication information is compared with the registration biometric samples to produce either a successful or failed identification of the customer in a customer identification step. As a result, a customer can access financial accounts without having to use any tokens such as portable man-made memory devices, smartcards or swipe cards. This allows customers to quickly select one of a group of different financial accounts. This tokenless biometric identification system does not recognize the tradesman as a member of a professional trade and provide specialized discounts.

U.S. Pat. No. 5,291,560 to Daugman discloses a biometric personal identification system based on iris analysis. A system for rapid and automatic identification of persons has very high reliability and confidence levels. The iris of the eye is used an optical fingerprint, having a highly detailed pattern that is unique for each individual and stable over many years. Image analysis algorithms find the iris in a live video image of a person's face, and encode its texture into a compact signature, or “iris code.” Iris texture is extracted from the image at multiple scales of analysis by a self-similar set of quadrature (2-D Gabor) bandpass filters defined in a dimensionless polar coordinate system. The sign of the projection of many different parts of the iris onto these multi-scale quadrature filters, determines each bit in an abstract (256-byte) iris code. The degrees-of-freedom in this code are based on the principle forms of variation in a population of irises studied. Because of the universal mathematical format and constant length of the iris codes, comparisons between them are readily implemented by the Exclusive-OR (XOR) logical operation. Pattern recognition is achieved by combining special signal processing methods with statistical decision theory, leading to a statistical test of independence based on a similarity metric (the Hamming distance) that is computed from the XOR of any two iris codes.

This measure positively establishes, confirms, or disconfirms, the identity of any individual. It also generates an objective confidence level associated with any such identification decision. This iris analysis method is not used to allow a tradesman to purchase business supplies at a retailer.

U.S. Pat. No. 8,553,948 to Hanna discloses a system and method for iris data acquisition for biometric identification. This system and method is for acquiring high quality images of the iris of an unconstrained subject. It comprises a camera; a controllable focusing component; a focus controller component that controls the lens to focus at successively different points within a focus range. The focus control is performed without any input from measurement of whether the image is in focus or out of focus, be it based on measurements of the image or other distance metrics to the subject. A sharpness detection component rejects the most out-of-focus images based on measurement of focus on the image. This iris analysis method is not used to allow a tradesman to purchase business supplies at a retailer.

U.S. Pat. No. 9,639,740 to Ganong et al. discloses face detection and recognition. This system provides methods and systems that (i) detect at least one face in at least one digital image, (ii) determine and store area co-ordinates of a location of the at least one detected face in the at least one digital image, (iii) apply at least one transformation to the at least one detected face to create at least one portrait of the at least one detected face, (iv) rotate the at least one portrait at least until the at least one portrait is shown in a vertical orientation and a pair of eyes of the at least one face shown in the at least one portrait are positioned on a horizontal plane; and (v) store the rotated at least one portrait. This face recognition method is not used to allow a tradesman to purchase business supplies at a retailer.

U.S. Pat. No. 7,938,319 to Newmark discloses a tradesman card system. A Tradesman's Card system issues a Tradesman's Card to a qualifying tradesman selected from the group consisting of plumbers, electricians, carpenters, masons, mechanics, repair shop professionals, contractors, or related construction or trade companies and professions upon payment of an initiation fee and payment of periodic maintenance fees. The card is issued by a bank or a credit card issuing authority that has contracted with pre-selected wholesalers, jobbers and businesses to provide pre-negotiated discount levels for tradesmen within the group. The tradesman's Card has unique identification features, which identify the card holder as a professional tradesman that is entitled to pre-negotiated discounts. A number visible on the Tradesman's card serves as the system identification number and a credit card number. Professional purchases by the tradesman are tracked by the system, analyzed and reported to sponsoring manufacturers of goods, jobbers or wholesalers for a fee. The purchasing information can be used by merchants for marketing purposes and generation of special discounts on future purchases by the tradesmen. The card has a magnetic strip that has to be swiped and does not have a chip in the tradesman credit card. The tradesman must present the Tradesman card and is not identified using biometric data.

There remains a need in the art for the recognition of a tradesman using a means of identification, such as a drivers, license, biometric data or the like without need for a card of any kind, wherein recognition of tradesman status provides discounts at a retail location or online from an ecommerce website, or rebates from a manufacture that recognizes a tradesman as a part of specialized group of professionals, the group consisting of plumbers, electricians, carpenters, masons, mechanics, repair shop professionals, contractors, or related construction or trade companies purchasing a quantity of trade supplies from wholesalers and using specialized services of jobbers deserving specialized treatment, including discounts. There is also a need for wholesalers and manufacturers to receive the discount level through recognition as a tradesman in a system that provides credit to the tradesman based on a personal account, thereby blurring the lines between business and personal credit. In doing so, the tradesman is provided with additional credit for purchases by receiving additional discounts available for tradesman purchases based on purchase volume, product brand and the like.

### SUMMARY OF THE INVENTION

The present invention provides a Tradesman Business Purchase System wherein a Tradesman that purchases business goods and services is identified at the point of purchase as a member of a professional group optionally without the need for presenting a credit card. The tradesmen business purchase system initially registers a tradesman selected from a group consisting of plumbers, electricians, carpenters, masons, mechanics, repair shop professionals, contractors, or related construction or trade companies, teachers/professors, hairstylists, musicians, cooks, bartenders, hotel or vacation rental managers, realtors, farmers/agricultural workers, accountants/bookkeepers, web developers/software developers/computer programmers, landscapers, engineers, contractors (general/electrical/flooring/siding/residential/commercial/plumbers/roofers/carpenters), healthcare practitioners and technical workers (doctors/nurses/physical therapists), scientists, religious workers/clergy, lawyers, fitness industry workers (athletic trainers), actors/film industry workers, graphic designers, interior designers, photographers, dentists, veterinarians, massage therapists, chiropractors, pharmacists, police, firefighters, EMTs, childcare workers, travel agents, pilots/flight engineers/flight attendants at a bank or credit issuing authority for purchases made for their profession. During initial registration into the tradesmen business purchase system, fingerprint and other biometric data including face recognition, palm print and iris scan are optionally collected. The tradesman opens a business account at the bank or credit issuing authority and a credit limit for professional purchases is set by the bank or credit issuing authority based credit worthiness. The bank or credit issuing authority determines credit worthiness based on certain parameters, such as fico score, etc. Credit worthiness is optionally based in part on a personal savings account maintained at the bank and other financial assets available to the tradesman. During registration, the tradesman provides tradesman's name, profession, and license, or any other identifier which proves that the tradesman is within a specific trade. The business account credit limit is set by the bank and is available for tradesman's purchases. The bank or credit issuing authority provides access to the tradesman business purchase system by linking the tradesman's biometric data without need for a credit card or other forms of identification; however, a credit card can be used independently or in connection with the biometric data, if desired. Additionally, the tradesman may provide to the bank or credit issuing authority names of merchants that regularly provide tradesman's supply merchandise, and the bank may negotiate a discount level that is available for the tradesman at the merchant location. The list of pre-negotiated discount levels at different merchant locations is provided to the tradesman. Purchases made at selected merchant locations by the tradesman are subject to discounts for purchases and/or manufacturer rebates. The business account at the bank that provides the line of credit has billing procedures similar to a conventional credit card account. A bill for purchases made using the tradesman business purchases is provided to the tradesman every month. Such a bill may be paid in full within a grace period of typically 30 days without incurring any interest charges. At least a minimal bill payment is required by the tradesman to maintain the business account at the bank and the remaining bill balance is subject to interest charges. Payment within a period less than the grace period can, optionally, be subject to cash back at the discretion of the lender.

The tradesman is recognized at a merchant location by being part of the tradesman system. Recognition is, optionally, first achieved by the fingerprint of the tradesman. The collected fingerprint data is transmitted through secure Internet to the tradesman purchasing system remote computer to validate the identity of the tradesman. A second biometric data is optionally selected from palm print, face recognition and iris scan, depending on the equipment available at the merchant location. Clearly fingerprint is the easiest while face recognition requires a video camera and computer software. Palm print requires a scanner and computer interface. The most difficult recognition method is iris scan, commonly present in military locations. When optionally utilized, an iris scan is collected and transmitted through secure Internet to the tradesman purchasing system remote computer. The tradesman's identity can optionally be established via blue tooth transmission from the tradesman's cell phone. Once the validity of the tradesman is established, purchases can be made at the merchant location and charged to the tradesman business account in the tradesman purchasing system. This method is especially well suited for purchasing goods or services from a plurality of wholesalers or jobbers at a pre-negotiated or merchant provided discount level or merchant provided discount levels as being distinct from the tradesperson that has not been distinguished as a professional and has not attained a recognized “Tradesman” status.

Advantageously, the tradesman purchase system provides the ability for a jobber or wholesaler/supplier to immediately recognize the purchaser as a professional in the trade field. Recognition of professional tradesmen purchasers allows the jobber or wholesaler to provide discounts, track purchases, quantities, and the like associated with specific tradesmen and trade companies. It also allows the card issuer to track purchases, quantities and the like to thereby target purchases and identify purchasing and marketing opportunities for the tradesman, manufacturer and wholesaler. The wholesaler or jobber can target their marketing to these specific industries and thereby service expanding tradesman markets. Payment at point of purchase is also enabled through use of the tradesman purchase system, since the purchase is funded by an active business account at card issuing bank. This decreases merchant's overhead and rolling capital needed for the wholesalers or jobbers. A tradesman using the tradesman purchase system would be nationally recognized. The tradesman would qualify for special pricing and would have his/her profession validated. Moreover, a tradesman could simply apply for and participate in the tradesman purchase system to be utilized with a variety of wholesalers, suppliers or retailers so that the tradesman does not have to apply for lines of credit from each individual wholesaler, supplier or retailer. With the utilization of a tradesman purchase system, a tradesman's purchases would be electronically processed and the charges would be accumulated in the tradesman purchase system.

The process of the tradesman applying for a tradesman purchasing system includes optionally collecting biometric data of the tradesman including fingerprint, face recognition, palm print and iris scan. The tradesman applies for a business account at the bank or credit issuing authority and submits proof that he is a member of a specific trade. The bank or credit issuing authority, after evaluating the professional details of the tradesperson, issues a line of credit, which is linked to the tradesman purchase system, thereby funding tradesman business purchases. The merchant recognizes the tradesman during purchases by biometric data of fingerprint and, optionally, one additional biometric measurement selected from face recognition, palm print, iris scan or other identification mechanism.

The tradesman purchase system has an associated credit card; but may optionally provide for recognition of the tradesman uniquely by biometric information, blue tooth or other identification mechanism. The tradesman purchase system optionally comprises: (i) a tradesman being recognized first by finger print and one additional biometric measurement; (ii) the optionally additional biometric measurement including face recognition or palm print that uniquely identifies the hand shape and features or iris scan; (iii) said tradesman purchasing system having an Internet accessible data base having stored tradesmen specific information, including biometric data, tradesman license number, type of trade or profession indicating that the tradesman is a professional and should receive discounts on professional purchases, and (v) expiration date of the tradesman purchasing system. In a preferred embodiment, the tradesman purchasing system may be issued by a credit issuing authority or bank, wherein the biometric identification of the tradesman generates appropriate pre-negotiated or merchant provided discount at wholesalers or jobbers' locations, creating a transaction that computes appropriate discount levels. The final bill reflects the discount and the purchase registered through the tradesman purchasing system.

### BRIEF DESCRIPTION OF DRAWINGS

The invention will be more fully understood and further advantages will become apparent when reference is had to the following detailed description and the accompanying drawings, in which:

FIG. 1 is a schematic view of the steps involved when the tradesman signs into the tradesman purchase system;

FIG. 2 illustrates the steps for the tradesman to make a business purchase at a merchant selling location; and

FIG. 3 illustrates the purchase process using the tradesman purchase system at a merchant location.

### DESCRIPTION OF THE PREFERRED EMBODIMENTS

This invention relates to a tradesman purchasing system tailored for use by tradesmen. It is issued by a bank or credit issuing authority by optionally first collecting biometric data of the tradesman, including face recognition, finger print, palm print and iris scan. The tradesman sets up a business account that has an amount of deposit funding partially comprising a line of credit issued by the bank or credit issuing authority. The tradesman optionally has a personal savings account at the bank, and the account balance in combination with other assets of the tradesman is the base for the line of credit issued by the bank. A tradesman purchasing system optionally links the tradesman business purchases to the line of credit. A minimum payment may be required every month to maintain the line of credit and when only minimum payment is made, the remaining balance of the bill is subject to finance charges. Failure to pay the minimum amount may result in a late payment fee.

There are approximately two million trade companies, including plumbers, electricians, carpenters, masons, repair shops, and the like, employing approximately five million employees. Billions of sales dollars are generated by these electric, plumbing and construction related businesses through the purchase of vital supplies, parts, materials, tools and services. More than five hundred thousand wholesalers or jobbers service this expanding market. With so many do-it-yourselfers, it is becoming increasingly difficult for wholesalers or jobbers to distinguish skilled trade professionals from amateurs. As a result, wholesalers or jobbers cannot immediately recognize and track purchase and spending of the professionals, and cannot offer specific purchase incentives to these large volume purchasers. Moreover, to validate the importance of their craft, the tradesmen themselves should be recognized and distinguished from non-professionals that do not belong to a group entitled to tradesman status.

Generally, the ability of a small tradesman to obtain business credit at a bank strictly based on business details is generally difficult due to the modest size of the tradesman's business. Also there are banking regulations that require scrutiny of business details of the tradesman using third party companies before issuing a line of credit to the business. The process of the tradesman purchasing system as detailed in the subject invention avoids the complicated business credit process of providing a business line of credit to the tradesman at the bank. The key requirement for extension of credit involves submission of proof to verify that the applicant is a member of a professional group entitled to recognition as a Tradesman, and has, in fact, achieved Tradesman status. Optionally, the credit worthiness of the Tradesman is further established by providing details of a personal bank savings account maintained at the bank or credit issuing authority as well as additional financial resources of the tradesman. After review of the financial details, a line of credit is provided by the bank or credit issuing authority and is available for tradesman business purchases. This procedure of creating a business account with the deposit of a line of credit at the bank funding tradesman credit card professional purchases blurs the requirement for a business line of credit funding tradesman credit card purchases by the incorporation of tradesman's personal financial resources. This line of credit issued by the bank or credit issuing authority is generally smaller in amount as compared to the personal savings account in combination with other tradesman's assets declared, since the personal savings account balance may change dynamically depending on withdrawals from the savings account and deposits into the saving account. On the other hand, it need not always be smaller, since the key determinant involves proof that the applicant has attained recognition and enjoys membership in a recognized professional group accorded Tradesman status. Accordingly, in one aspect of the Tradesman System, the bank actively tracks the tradesman's personal savings account in order to allow or decline charges made by the tradesman using the tradesman business purchasing system. Banks are reluctant to provide a business loan to a small business or tradesman since the business acumen of the tradesman must be first determined, typically by a Dunn and Bradstreet report and the like. Since small businesses do not have a large business history, they are oftentimes denied credit. This denial of credit has two consequences. 1) The tradesman does not have a line of credit or business account funded by a bank; 2) The amount of loans extended by the bank are correspondingly reduced, preventing the bank from raising income from interest and late payment changes. The Tradesman purchase system avoids this inherent problem and provides a tradesman with a line of credit and method for purchasing goods or services from a wholesaler or jobber at a pre-negotiated discount.

Briefly stated, the tradesman purchase system is provided solely to trade professionals selected from the group consisting of plumbers, electricians, carpenters, masons, mechanics, repair shop professionals, contractors, or related construction or trade companies, teachers/professors, hairstylists, musicians, cooks, bartenders, hotel or vacation rental managers, realtors, farmers/agricultural workers, accountants/bookkeepers, web developers/software developers/computer programmers, landscapers, engineers, contractors (general/electrical/flooring/siding/residential/commercial/plumbers/roofers/carpenters), healthcare practitioners and technical workers (doctors/nurses/physical therapists), scientists, religious workers/clergy, lawyers, fitness industry workers (athletic trainers), actors/film industry workers, graphic designers, interior designers, photographers, dentists, veterinarians, massage therapists, chiropractors, pharmacists, police, firefighters, EMTs, childcare workers, travel agents, pilots/flight engineers/flight attendants, for purchases made at professional trade companies, including wholesalers or jobbers. The tradesman purchase system provides a tradesman with a method and system for purchasing goods or services from a wholesaler or jobber, a retail store, or manufacturer at a specialized discount. It recognizes the profession of the tradesman as being distinct from that of a purchaser that has not achieved recognition as a member of a professional group that is entitled to Tradesman status. Advantageously, the tradesman purchase system charges for purchases to be directed to the business account at the bank at the time of purchase or, optionally, to the credit institution that funds the purchase.

The tradesman purchase system readily distinguishes the professional tradesman from the individual that has not achieved Tradesman status. Advantageously, the tradesman purchase system provides the ability for a jobber or wholesaler/supplier to immediately recognize the purchaser as a professional in the trade field. Recognition of professional tradesmen purchasers allows the jobber or wholesaler to track purchases, quantities, and the like associated with specific tradesmen and trade companies. The wholesaler or jobber can target their marketing to these specific industries and individuals thereby providing service to expanding markets. Payment at point of purchase is also enabled through use of the tradesman purchase system. This decreases overhead and rolling capital needed for the wholesalers or jobbers who traditionally extend lines of credit to individual companies. A tradesman using the tradesman purchase system would be nationally recognized. The tradesman would qualify for special pricing and would have his/her profession validated. Moreover, a tradesman could simply apply for and receive a registration in tradesman purchase system from the issuer to be utilized with a variety of wholesalers so that the tradesman would not have to apply for lines or credit from each individual wholesaler. With the utilization of a tradesman purchase system, a tradesman's purchases would be accumulated in a tradesman business account. Consequently, any purchase at a predetermined wholesaler or jobber within the tradesman's profession automatically confers a pre-negotiated discount for goods and services purchased and used professionally by the tradesman.

When a tradesman applies for a tradesman purchase system at a bank or credit issuing authority, an initiation fee may be charged and the tradesman is issued a line of credit linked to the tradesman purchasing system. The tradesman signs an authorization that enables the bank or credit card issuing authority to divulge or disclose the purchases made by the tradesman to a third party. This permits the bank or card issuing authority to disclose the purchase patterns of a tradesman of a particular trade in an agglomerated or detailed format to manufacturers of goods, wholesalers and the like. In this manner, the cardholder agreement can authorize release of purchasing information. Manufactures wishing to increase their business through acquisition of new customers can procure this valuable information for an agreed upon consideration. Wholesalers and distributors can thereby increase their business with new customers without having to finance the additional accounts receivables.

The tradesman purchase system has an initiation date of the membership. The tradesman must make periodic payments to maintain his status as a member of the tradesman purchasing system. The membership status of the tradesman is stored by the bank or credit issuing authority and is verified each time the tradesman purchasing system is used for a purchase. Upon initiation, the tradesman is provided with a list of wholesalers and jobbers that provide a pre-negotiated discount under the tradesman's credit card service. For each of these wholesalers, a pre-negotiated amount of discount is indicated. The tradesman may receive periodic discounts or rebates from manufacturers, wholesalers or jobbers to support specific products or services by virtue of belonging to the tradesman purchasing system.

Generally stated, the invention comprises a tradesman purchase system that includes a bank or credit issuing authority capable of providing a unique service for a tradesman selected from a group consisting of plumbers, electricians, carpenters, masons, mechanics, repair shop professionals, contractors, or related construction or trade companies, teachers/professors, hairstylists, musicians, cooks, bartenders, hotel or vacation rental managers, realtors, farmers/agricultural workers, accountants/bookkeepers, web developers/software developers/computer programmers, landscapers, engineers, contractors (general/electrical/flooring/siding/residential/commercial/plumbers/roofers/carpenters), healthcare practitioners and technical workers (doctors/nurses/physical therapists), scientists, religious workers/clergy, lawyers, fitness industry workers (athletic trainers), actors/film industry workers, graphic designers, interior designers, photographers, dentists, veterinarians, massage therapists, chiropractors, pharmacists, police, firefighters, EMTs, childcare workers, travel agents, pilots/flight engineers/flight attendants. These tradesmen purchase substantial amounts of merchandise in the course of their work, and use for their purchase specialized wholesalers or jobbers. The bank or credit issuing authority negotiates with wholesalers and jobbers for discount levels applied to tradesman trade related purchases using the tradesman's credit card system. A number of manufacturers may sponsor the tradesman purchasing system and may be involved in receiving on a periodic basis the details of purchases made by tradesmen when practicing their profession, thereby having a ground level view of market acceptability of a manufacturer's product. The manufacturer may influence the purchases made by the tradesman for using their trade by offering a discount or incentive as well as changing the advertisements in the media to control the overall acceptance of the manufacturer's product.

When equipped with the attributes of the present invention, the tradesman purchase system becomes a marketing tool for trade people. Importantly, it identifies the user as a certified and/or qualified buyer, and member of a particular field. Upon fitting the profile for the tradesman credit card, a buyer becomes eligible for the privileges of others in that field. These privileges can include special discounts, bonuses and premiums. Purchases by the tradesman purchase system are tracked by and provided to manufacturers or wholesalers so that other offers can be granted. Information derived from this tracking capability has significant value for manufacturers of purchased products. Consider, for example, the case of a mechanic holding a membership in a purchase system wherein Brand M is the purchase system sponsor, and making large volume purchases of brand G shock absorbers. In this situation, the purchase system sponsor (Brand M) can make the tradesman a generous offer to switch brands in the future. This advantageous relationship between a purchase system sponsor and a tradesman extends into other fields. For example, it could be used to differentiate decorators going to furniture and wall covering showrooms from persons doing their own decorating. Flower and gift shop personnel going into show rooms can be identified as true shop owners. Food and equipment wholesalers can identify and extend benefits to a true restaurateur. A carpenter from a remote location within a state that runs short of 2×4s can go to the local lumber yard that belongs to the tradesman purchase system, and be qualified to purchase at that yard's wholesale prices. The carpenter is accorded a significant convenience, and the lumberyard gains an opportunity to acquire a new volume customer.

Some of the larger fields for which the tradesman purchase system is especially well suited include, for example: (i) within the construction field all of the special trades; (ii) agriculture, farming, landscaping, and the like; (iii) service people; janitorial, pools, specialty services like telephone and information technology; (iv) doctors, nurse practitioners, and medical personnel; (v) lawyers, paralegals, and office managers; (vi) engineers, scientists, accountants and laboratory technicians.

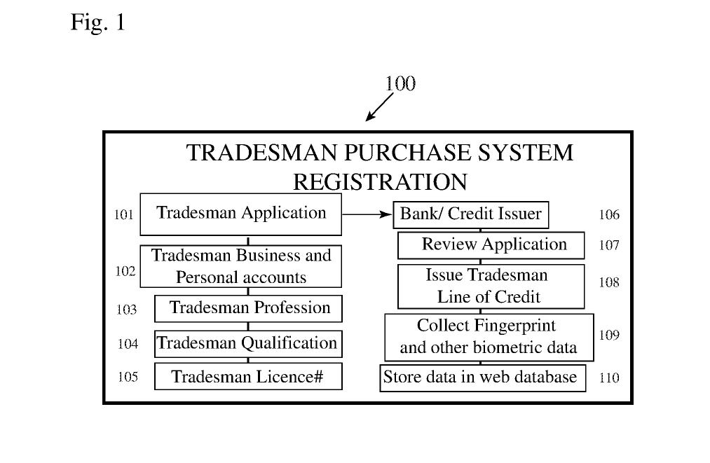

FIG. 1 schematically illustrates at 100 the steps involved in the tradesman registering into the tradesman purchase system. At step 101 the tradesman fills in an application for membership in the tradesman purchase system. At step 102, the tradesman provides financial details of business and personal accounts. At step 103, the tradesman's profession is indicated and the purchase system will find suitable merchants and services. The tradesman qualification and licenses are declared as steps 104 and 105. The bank or credit issuer 106 receives all these tradesman data and reviews it at 107. When the data is adequate the bank credit issuer provides a line of credit to the tradesman at step 108. At this stage, step 109 collects the fingerprint and biometric information of the tradesman. Step 110 stores biometric data of the tradesman and line of credit is provided in a web based database accessible by merchants when the tradesman is recognized.

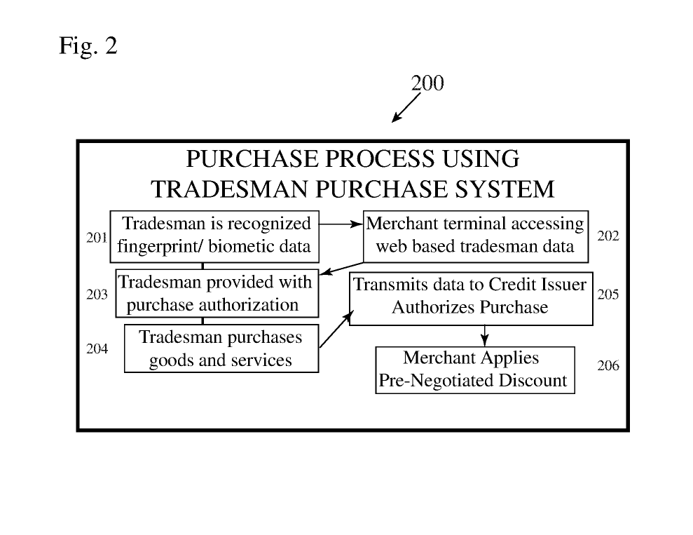

FIG. 2 illustrates at 200 the steps involved for the tradesman making a business purchase at a merchant selling location. At step 201, the tradesman places his thumb to provide a fingerprint and this fingerprint data is communicated at step 202 to the web based remote database to identify the tradesman. Preferably, a second biometric data is optionally acquired, which may be a face recognition, palm scan or iris scan depending on machinery available at the merchant location. Clearly fingerprint, video camera and palm print scanner are readily available, while iris scan oftentimes requires specialized equipment. Once the tradesman is uniquely identified, he is provided with purchase authorization at step 203. The tradesman purchases goods and services at step 204 and this purchase information is transmitted to the credit issuer in step 205 thereby authorizing the purchase. At step 206, the merchant provides a special pre-negotiated discount.

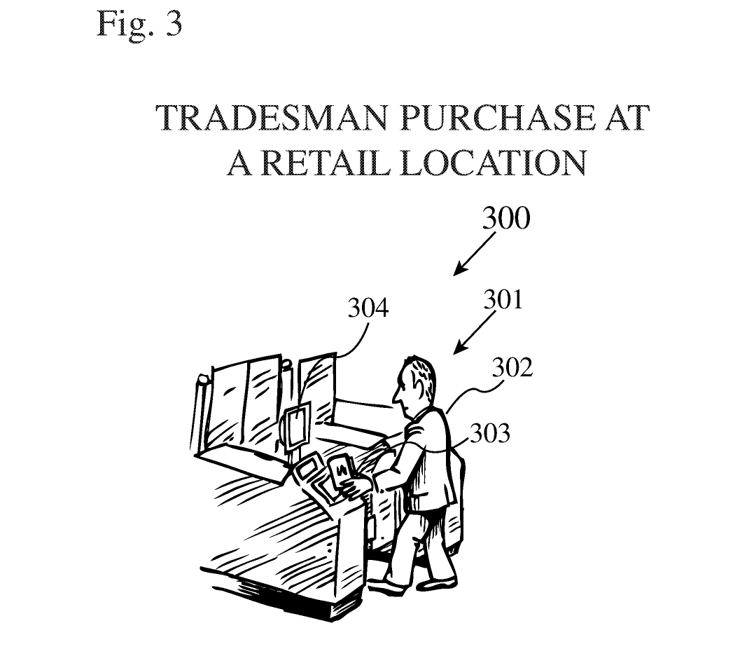

FIG. 3 illustrates at 300 a pictorial representation of the purchase process using the tradesman purchase system at a merchant location. The tradesman 302 comes to the biometric measurement system 301 and presents a tradesmen's card and/or places the thumb on fingerprint sensor 303. The fingerprint data is transmitted to the web based purchase system database and is compared to identify the tradesman. Preferably, a second biometric data is utilized to uniquely identify the tradesman. In this figure, a video camera 304 is turned on to capture the face picture, which is transmitted to the web based purchase system database and compared to provide face recognition. Other biometric measurements including palm shape scan and iris scan may be used, as well. It will be understood that instead of utilizing a fingerprint as the first biometric scan, at least one of face recognition, palm scan and iris scan could be utilized. In this event, a fingerprint could optionally constitute one of the second biometric measurements used to verify the identity of the tradesman. At this stage, the tradesman is positively identified and is free to shop at the merchant location. All purchases made are brought to station 301, which checks out purchases billed through the web based purchase system database, accumulating the charges in the tradesman's business line of credit.

The tradesman business purchase system comprises, in combination, the following salient features:
1. a tradesman business purchase system made available to a tradesman selected from the group consisting of plumbers, electricians, carpenters, masons, mechanics, repair shop professionals, contractors, or related construction or trade companies;
2. said tradesman business purchase system operated by a bank or credit issuing authority that verifies the status of the tradesman as belonging to a recognized group of professionals and, optionally, evaluates the financial status of a tradesman and provides a business line of credit upon payment of an initiation fee and periodic maintenance fees;
3. said tradesman being provided with a list of wholesalers and jobbers that have agreed to provide a pre-negotiated discount for purchase of trade merchandise and services;
4. said tradesman providing a tradesman's card and/or a number of biometric identification data including fingerprint, face recognition, palm scan and iris scan at the time of initiation and biometric data of the tradesman being stored in a web based remote database along with the value of said business line of credit;
5. said tradesman being recognized at a merchant location by fingerprint and, optionally, a second biometric data selected from face recognition, palm print scan, iris scan each verified by the remote web based tradesman purchase system database;
6. use of said tradesman purchase system by a tradesman for the purchase of business merchandise at said wholesalers or jobbers results in allowance or decline of charges by a web based purchase system database and accumulating charges in the tradesman business account and automatic generation of pre-negotiated discounts for said trade purchases;
7. said trade purchases by the tradesman tracked by said bank or credit issuing authority and information analyzed to provide valuable marketing information for manufacturers of goods, service providers and wholesalers on a fee payment basis;

whereby the tradesman's profession is recognized by the use of the tradesman purchase system at wholesaler and jobber locations, expanding the type and flexibility of discounts for trade specific goods and services purchased and used professionally by the tradesman.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A tradesman business purchase system, comprising:
a. said tradesman purchase system provided by a bank or credit issuing authority evaluating the financial and professional status of a tradesman providing a business line of credit optionally upon payment of an initiation fee and periodic maintenance fees;
b. said tradesman selected from the group consisting of plumbers, electricians, carpenters, masons, mechanics, repair shop professionals, contractors, or related construction or trade companies, teachers/professors, hairstylists, musicians, cooks, bartenders, hotel or vacation rental managers, realtors, farmers/agricultural workers, accountants/bookkeepers, web developers/software developers/computer programmers, landscapers, engineers, contractors (general/electrical/flooring/siding/residential/commercial/plumbers/roofers/carpenters), healthcare practitioners and technical workers (doctors/nurses/physical therapists), scientists, religious workers/clergy, lawyers, fitness industry workers (athletic trainers), actors/film industry workers, graphic designers, interior designers, photographers, dentists, veterinarians, massage therapists, chiropractors, pharmacists, police, firefighters, EMTs, childcare workers, travel agents, pilots/flight engineers/flight attendants;
c. said tradesman during initiation providing indicia that proves tradesman status, such indicia including a license, certification, degree, or other identification mechanism that proves membership in a particular trade, and, optionally, a number of biometric identification data including fingerprint, face recognition, palm scan and iris scan, said biometric data of the tradesman being stored in a web based remote database along with value of said business line of credit;
d. said tradesman being provided with a list of wholesalers and jobbers and manufacturer rebates that have agreed to provide a pre-negotiated discount for purchase of trade merchandise and services;
e. said tradesman being recognized at a merchant location or on line at an ecommerce website as being part of the tradesman system optionally by a credit card, or verification of a tradesman license number, or by a first biometric scan verified by the remote web based tradesman purchase system database;
f. said tradesman being optionally recognized additionally at a merchant location by a second biometric scan verified by the remote web based tradesman purchase system database;
g. use of said tradesman purchase system by a tradesman for the purchase of business merchandise at said wholesalers or jobbers resulting in allowance or decline of charges by web based purchase system database and accumulating charges in the tradesman business account and automatic generation of pre-negotiated discounts for said trade purchases;
h. said trade purchases by the tradesman tracked by said bank or credit issuing authority and purchase information analyzed to validate and provide valuable marketing information for manufacturers of goods, service providers and wholesalers on a fee payment basis;
whereby the tradesman's profession is recognized by the presentation of the tradesman credit card at wholesaler and jobber locations, providing discounts for trade specific goods and services purchased and used professionally by the tradesman.

2. The tradesman business purchase system as recited by claim 1, wherein said first biometric scan is a fingerprint verified by the remote web based tradesman purchase system database.

3. The tradesman business purchase system as recited by claim 1, wherein said biometric scan includes a second biometric scan selected from face recognition, palm print scan and iris scan, each verified by the remote web based tradesman purchase system database.

4. The tradesman business purchase system as recited by claim 1, wherein said second biometric scan is face recognition verified by the remote web based tradesman purchase system database.

5. The tradesman business purchase system as recited by claim 1, wherein said second biometric scan is palm scan verified by the remote web based tradesman purchase system database.

6. The tradesman business purchase system as recited by claim 1, wherein said financial status of the tradesman for providing tradesman business line of credit includes evaluation of tradesman assets in combination with tradesman personal savings account at the bank for funding tradesman business account at the bank.

7. The tradesman business purchase system as recited by claim 1, wherein the tradesman may charge purchases to a business account at the bank or credit issuing authority that manages tradesman purchase system.

8. The tradesman business purchase system as recited by claim 1, wherein said discount on trade purchases by the tradesman are provided by communication between merchant purchase processing machinery and web based remote tradesman business purchase system database by Bluetooth, Wi-Fi or wired connection.

9. The tradesman business purchase system as recited by claim 1, wherein said tradesman is provided with instant credit for trade specific business purchases without having to open charge accounts at a plurality of wholesalers, jobbers or other commercial organizations.

10. The tradesman business purchase system as recited by claim 1, wherein said wholesalers, jobbers or other commercial organizations are relieved from opening credit lines for tradesmen in order to attract a tradesman's business purchases.

11. The tradesman business purchase system as recited by claim 1, wherein said tradesman business purchase system is sponsored by manufacturers of goods, service providers and wholesalers optionally upon payment of an initial sponsorship fee and periodic payment of fees for tradesman professional purchase reports.

12. The tradesman business purchase system as recited by claim 11, wherein said professional purchase report includes brand specific purchase details and product details that meet end use customer preferences.

13. The tradesman business purchase system as recited by claim 11 wherein said manufacturers of goods, service providers and wholesalers set up additional discounts for tradesman professional purchases or provide incentives.

14. A process for obtaining a tradesman business purchase system comprising:
a. tradesman filling an application at the bank or credit issuing authority in which the tradesman has a personal savings account requesting a line of credit;
b. said tradesman receiving a line of credit deposited to a business account of the tradesman;
c. said bank or credit issuing authority working with tradesman referred merchants and wholesalers or jobbers to generate a pre-negotiated discount or purchases made;
d. said bank or credit issuing authority authorizing or declining the purchase by reviewing tradesman's submission of proof that he is a member of a recognized group of professionals entitled to tradesman status and, optionally, reviewing tradesman's personal savings account and balance in a business account funded by a line of credit issued;
e. said business purchases automatically providing pre-negotiated discounts for business purchases at selected merchant locations;
whereby the tradesman has flexibility to direct the charges for purchase to the business account and pay in full upon receipt of a monthly bill from the bank or credit issuing authority and pay monthly bill only partially as a function of timed payments.
